(19) United States
(12) Patent Application Publication
(10) Pub. No.: US 2015/0238386 A1
(43) Pub. Date: Aug. 27, 2015

(54) Wallet Medication Card

(71) Applicant: Matthew William Wallace, Alamo, CA (US)

(72) Inventor: Matthew William Wallace, Alamo, CA (US)

(21) Appl. No.: 14/631,836

(22) Filed: Feb. 25, 2015

Related U.S. Application Data
(60) Provisional application No. 61/945,563, filed on Feb. 27, 2014.

(51) Int. Cl. A61J 1/03; B65D 75/36

(52) U.S. Cl. CPC A61J 1/035; B65D 75/36; A61J 2205/10

(57) ABSTRACT

A personal wallet medication card apparatus which is at most the dimensions of a credit card and having at least one sealed cavity which conveniently and safely retains medication for use in an emergency. One embodiment of the present invention facilitates telecommunication with medical persons or entities in an urgent medical event by using a scannable code encoding a prompt on a mobile telecommunication device for medical communications or other information.

### CROSS REFERENCE TO RELATED APPLICATIONS

This application claims the benefit of U.S. Provisional Patent Application No. 61/945,563 filed Feb. 27, 2014.

### FIELD OF THE INVENTION

The present invention discloses a personal wallet medication card apparatus with a back side and a front side opposite the back side. The front side has at least one sealed cavity designed for securely housing medication. The personal wallet medication card is generally the dimension of a credit card, and, more particularly, may to aid in the communication with persons or entities in the event that an urgent medical situation is present.

### BACKGROUND OF THE INVENTION

Occasionally people are required to take medication on an emergency basis in order to ameliorate potentially serious detrimental health results. For example, ingesting aspirin at the first signs of a heart attack can assist in medical treatment of the patient and may even save the patient's life. Devices that can be easily be transported and used to retain personal medication doses for convenience have long been used, the simple pillbox being one common example. Another common method of retaining medication in pre-determined dosages is the well known “blister packaging” which is generally used for medication in pill form.

A convenient, easily transportable personal medication-dispensing apparatus, which safely retains medication in blisters and is generally the dimensions of a credit card, with a top surface of about 85 mm by about 54 mm, and less than 90 mm by 60 mm, could aid in treatment of a patient by enabling the patient to keep their medication in a convenient location, such as a wallet or small purse. Indeed, blister packaging has been used to retain medications in various sized medication retaining devices, including a credit card-sized device. For example, U.S. Pat. No. 4,889,236 discloses a “credit card-style medication package” that contains blister pack housed medications located throughout the top surface of the device, which, however, can make the device difficult to fit into the credit card pocket slot of a wallet due to the depth of the blisters filling a substantial portion of the top surface of the device and other items, such as credit cards, contained in the wallet. In another example, U.S. Pat. App. No. US2005/0056564 discloses a “wallet pill card” that has a plurality of blister pack-housed medications located on the top portion of one face of the device as well as writing on the device, such as an advertisement or instructions of how to ingest the medication. However, the clearly visible medication of the “wallet pill card” attempt, when inserted into a wallet as taught, may lead to inadvertent medication release due to the exposed nature of the blister packaging location on the outside of the protected wallet credit card slot. Such a location may also lead to the embarrassment of the carrier of the device in the event others are able to view the medication contained within and/or the writing on the device.

Often the administration of a medication should often be followed by medical treatment, even immediate medical treatment, and a medication-dispensing device that could facilitate aiding medical treatment services, including in an emergency situation, may assist or even save the life of the patient. In an attempt to address the need for a convenient location of medication in the event of an emergency, U.S. Pat. No. 6,471,063 discloses an “Emergency Pill Dispenser” that provides a blister package containing medication that can be attached with adhesive to a convenient location, such as to a telephone or briefcase. However, the device adhesive is designed not be removed from the object it is affixed to and therefore the user of the device could be prevented from retaining the medication close at hand if the device is attached to an object that is not in the same location as the user, such as if the device is attached to a telephone in the user's home or business.

Therefore, a need exists for a device that retains medication in a discreet, convenient size as well as an easy to use yet secure blister packaging design. Further, a need exists for a device that retains medication in a convenient size with a discreet, secure packaging design that can facilitate securing, contacting or aiding medical treatment services and/or medical information helpful to the user or other person assisting the user.

### SUMMARY OF THE INVENTION

It is therefore an object of the present invention to provide a fast, secure and convenient way to provide emergency medication when needed.

It is another object of the present invention is to overcome the limitations inherent in the personal medication dispenser devices listed above.

The present invention relates to a personal wallet medication card apparatus, comprising a card with a top surface, bottom surface opposite said top surface as well as a middle portion with at least one sealed cavity designed for securely housing medication facing outward from said top surface. The present invention top surface and bottom surface are at most the dimensions of a credit card with a top surface and bottom surface of less than 90 mm by 60 mm. Each sealed cavity, designed form securely housing medication and facing outward from the top surface of the card, is commonly known in the industry as blister packaging. As is well known in the art, the depth of a credit card is generally less than 1 mm, but the depth of the blister can vary depending on the dimensions of the medication housed within the blister. The blister packaging of the medication is designed to release the medication when pressure is applied to the blister thereby forcing the medication through an opposing side of the packaging.

The personal wallet medication card apparatus has writing on at least one surface of the card. In another embodiment, the personal wallet medication card apparatus has a scannable code on at least one of the card surfaces encoding medical contact information or other information. The scannable code may consist of a UPC code, a QR code or similar such code wherein the scannable code is encoded for prompting a phone number to dial or a text to send on a wireless telecommunication device. In yet another embodiment, said scannable code is encoded for prompting other information, such as medication instructions or other information on a device connected to a wireless network.

### BRIEF DESCRIPTION OF DRAWINGS

FIG. 1 is a front view of the Wallet Medication Card apparatus with blister pack sealed cavities and writing on the device.

FIG. 2 is a side view of the Wallet Medication Card apparatus with a blister pack sealed cavities on the device.

FIG. 3 is a front view of an embodiment of the Wallet Medication Card apparatus with blister pack sealed cavities on the device and a scannable code encoding a prompt when used with a smart phone, tablet or other scanning device.

### DETAILED DESCRIPTION OF PREFERRED EMBODIMENTS OF THE INVENTION

The present invention relates to a blister card that can provide convenient and discrete storage of medication in a wallet. The convenient and discrete storage of medication enables users to keep medication in their wallet while preventing other people from seeing that the medication card contains medication. Another embodiment of the invention enables users to keep medication in their wallet while preventing other people from seeing the that medication card contains medication and provides a scannable code to assist in contacting medical entities, such as persons, entities or electronic information sources, by a device connected to a wireless network or the internet. Scannable code to assist in contacting medical entities may prompt a communication, including without limitation a telephone number or a SMS (“Short Message Service” for sending textual messages between and among wireless devices connected to a wireless network, commonly referred to as a “text”) in order to facilitate calling, texting or otherwise communicating with a predesignated entity or person to assist securing medication information or assistance for the user.

The following text sets forth a broad description of a plurality of different embodiments of the present invention. The description is to be construed as exemplary only and does not describe every possible embodiment since describing every possible embodiment would be impractical, if not impossible, and it well be understood that any feature, characteristic, component, composition, ingredient, product, step or methodology described herein can be deleted, combined with or substituted for, in whole or in part, any other feature, characteristic, component, composition, ingredient, product, step or methodology described herein. Numerous alternative embodiments could be implemented, using either current technology or technology developed after the filing date of this patent, which would still fall within the scope of the claims. All publications and patents herein are incorporated by reference.

It should also be understood that, unless a term is expressly defined in this specification using the sentence “As used herein, the term ‘______’ is hereby defined to mean . . . ” or similar sentence, there is no intent to limit the meaning of that term, either expressly or by implication, beyond its plain or ordinary meaning, and such term should not be interpreted to be limited in scope based on any statement made in any section of this patent (other than the language of the claims). No term is intended to be essential to the present invention unless so stated. To the extent that any term recited in the claims at the end of this patent is referred to in this patent in a manner consistent with a single meaning, that is done for the sake of clarity only so as to not confuse the reader, and it is not intended that such a claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

The term “blister” refers to an enclosure formed by an outer covering that is raised at the face (otherwise referred to as the “top surface”) thereby forming a cavity for housing a medication unit dose. The blister is a sealed cavity with an opposing backing which is used to retain a medication until sufficient pressure is applied to the blister, forcing the medication to break through the backing and thereby releasing the medication from the sealed cavity.

The blisters can be made from a variety of materials, including without limitation polyvinyl chloride, thermoplastic materials, polyolefins, glycol-modified polyethylene terephthalate and combinations thereof. The layers of the rupture portion of the blister can also be made from a variety of materials, including without limitation metal foil, tempered metal foil, paperboard, polyvinyl chloride, polyester, polyolefins, polystyrenes, polyesters, fluoropolymer resins, and combinations thereof.

The wallet medication card apparatus backing material can be made of a variety of materials, including without limitation polyvinyl chloride, paper, plastic, and combinations thereof.

The term “UPC” refers to the Universal Product Code, a barcode consisting of an array of black and white lines of varying widths that symbolize numerical digits and can be scanned to read the information contained therein. The UPC code is designed to be scanned by a narrow beam of light.

The term “QR” refers to the Quick Response Code™, a machine-readable code consisting of an array of black and white squares, typically used for storing URLs or other information for reading by the camera on a mobile device, such as a smartphone. QR codes are well known and heavily used today, and, unlike the UPC code, the QR code is detected as a 2-dimensional digital image by a semiconductor image sensor and is then digitally analyzed by a programmed processor. The processor locates three distinctive squares at the corners of the image, normalizes image size, orientation, and angle of viewing with the aid of a smaller square near the fourth corner. The small dots are then converted to binary numbers and validity checked with an error-correcting code (From Wikipedia.com). The QR code, when scanned with a mobile device, including a mobile cellular telephone, results in immediate retrieval and prompting of a phone number to dial or a SMS text to send on a wireless telecommunication device. In yet another embodiment, said scannable code is configured to encode for prompting other information, such as medication instructions or other information on a device connected to a wireless network or the Internet.

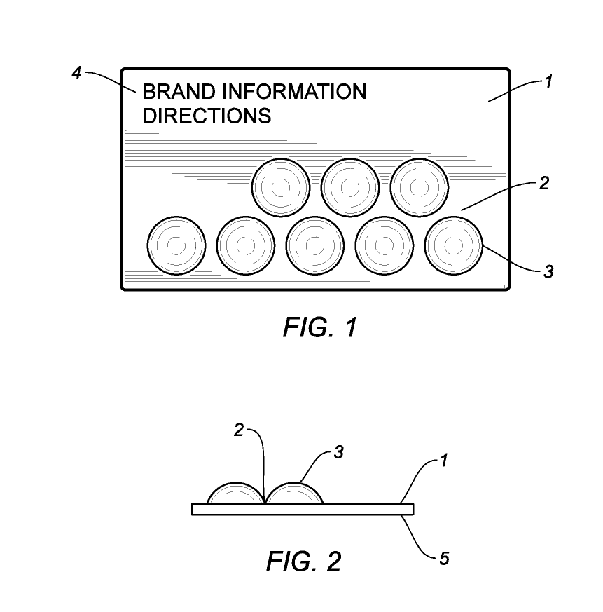

Referring to FIG. 1, A wallet medication card apparatus with a top surface 1, a middle portion 2 of said top surface, said middle portion 2 having at least one sealed cavity 3 designed for housing medication and facing outward from said top surface, and with writing 4 on at least one surface of the card. The writing can include alphanumeric characters, pictures, drawings, illustrations, photographs, computer-produced images, colors, textures, shapes, symbols, letters, numbers and combinations thereof. The size of the top surface of the wallet medication card apparatus is no larger than a credit card with the dimensions of less than 90 mm by 60 mm, with the depth of the wallet medication card apparatus variable depending upon the depth of the medication housed in the sealed cavity or cavities (blister or blisters), if more than one cavity is contained within the middle portion of the card.

Referring to FIG. 2, A wallet medication card apparatus is illustrated with a top surface 1, a bottom surface 5 opposite the top surface, and a middle portion 2, said middle portion having at least one sealed cavity 3 designed to house medication. The depth of the blisters housing the medication is illustrated here from this view of the wallet medication card apparatus.

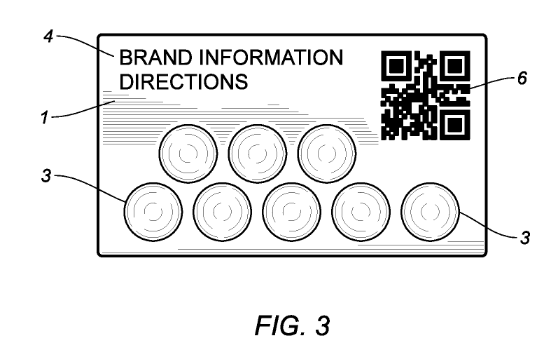

Referring to FIG. 3, A wallet medication card apparatus with writing 4 on at least one surface 1 and having at least one sealed cavity (blister) 3 designed to house medication and said card having a scannable code 6 encoding medical contact information on at least one surface for facilitating contact with medical entities located on at least one of said surfaces. The scannable code may be a UPC code or a QR code. The QR code can be scanned to prompt information on a device connected to a wireless network, including without limitation a phone number on a wireless telecommunication device to dial or a SMS (“text”) on a wireless telecommunication device to send. In another embodiment, the scannable code is encoded for prompting other information, such as medication instructions, physician information, treatment information or other information on a device connected to a wireless network.

Although the present invention has been described in considerable detail with reference to certain preferred embodiments thereof, other embodiments or versions will become apparent to those of ordinary skill in the art. Additionally, variations of additional wallet medication cards are possible. Therefore, the spirit and scope of the appended claims and the concepts taught therein should not be limited to the description of the preferred embodiments contained herein.

1. A wallet medication card apparatus comprising:
a card having a top surface,
a bottom surface opposite said top surface,
said card having writing on at least one said surface,
said top surface having a middle portion,
at least one sealed cavity within said middle portion and facing outward from said top surface, said sealed cavity configured for housing medication.

2. A wallet medication card apparatus of claim 1 wherein: said card top surface and bottom surface is less than 90 mm by 60 mm.

3. A wallet medication card apparatus comprising:
a card having a top surface
a bottom surface opposite said top surface,
said card having writing on at least one said surface,
said top surface having a middle portion,
at least one sealed cavity within said middle portion and facing outward from said top surface, said sealed cavity for housing medication,
a scannable code located on at least one of said surfaces, wherein said scannable code is configured to encode medical contact information for facilitating contact with medical entities.

4. A wallet medication card apparatus of claim 3 wherein: said scannable code is a UPC code.

5. A wallet medication card apparatus of claim 3 wherein: said scannable code is a QR code.

6. A wallet medication card apparatus of claim 5 wherein: said scannable QR code is configured to encode for prompting a phone number on a wireless telecommunication device.

7. A wallet medication card apparatus of claim 5 wherein: said scannable QR is configured to encode for prompting a SMS on a wireless telecommunication device.

8. A wallet medication dispensing card apparatus comprising:
a card having a top surface
a bottom surface opposite said top surface,
writing on at least one said surface,
a middle portion of said top surface,
at least one sealed cavity within said middle portion and facing outward from said top surface said sealed cavity configured for housing medication.
a scannable code on at least one of said surfaces, said scannable code configured to encoding at least one prompt for information on a device connected to a wireless network.
